(19) United States
(12) Patent Application Publication
(10) Pub. No.: US 2014/0009464 A1
(43) Pub. Date: Jan. 9, 2014

(54) ELECTRONIC APPARATUS AND DESKTOP IMAGE DISPLAY METHOD

(71) Applicant: KABUSHIKI KAISHA TOSHIBA, Tokyo (JP)

(72) Inventor: Fumitoshi Mizutani, Ome-shi (JP)

(73) Assignee: KABUSHIKI KAISHA TOSHIBA, Tokyo (JP)

(21) Appl. No.: 13/967,574

(22) Filed: Aug. 15, 2013

Related U.S. Application Data
(63) Continuation of application No. PCT/JP2013/057930, filed on Mar. 13, 2013.

(30) Foreign Application Priority Data
Jul. 5, 2012 (JP) 2012-151700

(51) Int. Cl. G06T 15/00

(52) U.S. Cl. CPC G06T 15/00
USPC 345/419

(57) ABSTRACT

According to one embodiment, an electronic apparatus includes a detection module, a processor, and a drawing module. The detection module detects an image from a plurality of images based on drawing order information and a drawing size of each of the plurality of images. The detected image matches a predetermined condition. The processor processes undetected images having failed to be detected by the detection module into processed images. Each of the processed images includes an image of a left perspective and an image of a right perspective. The drawing module draws the detected image and the processed images based on the drawing order information and the drawing position information items in order to generate the desktop image.

### CROSS-REFERENCE TO RELATED APPLICATIONS

This application is a Continuation Application of PCT Application No. PCT/JP2013/057930, filed Mar. 13, 2013 and based upon and claiming the benefit of priority from Japanese Patent Application No. 2012-151700, filed Jul. 5, 2012, the entire contents of all of which are incorporated herein by reference.

### FIELD

Embodiments described herein relate generally to an electronic apparatus that displays a desktop screen on a display screen of a display and a desktop image display method.

### BACKGROUND

In recent years, many 3D contents and many electronic apparatuses capable of providing 3D display have been commercially available and have been becoming familiar. When a desktop screen is displayed, a desktop image may be provided by preparing a wallpaper image for stereoscopic display, an application activation image that is used to activate an application, a system bar image, and the like, and drawing these images in order.

However, at present, the application activation image and the system bar image are intended for normal display, and not all the images may be configured for stereoscopic display. A normal video fails to be displayed when a desktop screen is displayed on a display screen of a display by drawing an image for stereoscopic display and an image for normal display in layer order without varying processing between these images.

Thus, the image for normal display and the image for stereoscopic display need to be distinguished from each other. After the image for normal display and the image for stereoscopic display are distinguished from each other, the image for normal display needs to be processed into an image suitable for stereoscopic display. Then, a normal video is displayed by drawing the processed image and the image for stereoscopic display in order to prepare a desktop screen and displaying the desktop screen on the display screen of the display.

Distinguishing the image for normal display from the image for stereoscopic display requires a special mechanism. Implementing and maintaining the mechanism is expensive.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the appearance of an electronic apparatus according to an embodiment.

FIG. 2 is an exemplary block diagram showing an example of a system configuration of the electronic apparatus in FIG. 1.

FIG. 3 is an exemplary diagram showing an example of a setup screen for a wallpaper image.

FIG. 4 is an exemplary block diagram showing a configuration for displaying a desktop screen on an LCD.

FIG. 5 is an exemplary diagram showing an example of a wallpaper image generated by a wallpaper image generation section.

FIG. 6 is an exemplary diagram showing an application activation image generated by an application activation image generation section.

FIG. 7 is an exemplary diagram showing an example of a system bar image generated by a system bar image generation section.

FIG. 8 is an exemplary diagram showing an example of a popup image generated by a popup image generation section.

FIG. 9 is an exemplary diagram showing an example of drawing information created by a drawing order/position specifying section.

FIG. 10 is an exemplary diagram showing an example of drawing information created by the drawing order/position specifying section.

FIG. 11 is an exemplary block diagram showing a configuration of a desktop image drawing section.

FIG. 12 is an exemplary diagram showing an example of an application activation image processed by an image processing section.

FIG. 13 is an exemplary diagram showing an example of a system bar image processed by the image processing section.

FIG. 14 is an exemplary diagram showing an example of a popup image processed by the image processing section.

FIG. 15 is an exemplary diagram showing an example of a popup image generated by the image processing section if the popup image is different from the LCD in the number of pixels arranged in a horizontal direction.

FIG. 16 is an exemplary diagram showing an example of drawing information with drawing position information changed by the image processing section.

FIG. 17 is an exemplary diagram showing an example of drawing information with drawing position information changed by the image processing section.

FIG. 18 is an exemplary diagram showing an example of an image drawn by a drawing section.

FIG. 19 is an exemplary diagram showing an example of an image drawn by the drawing section.

FIG. 20 is an exemplary diagram showing an example of an image drawn by the drawing section.

FIG. 21 is an exemplary diagram showing an example of an image drawn by the drawing section.

FIG. 22 is an exemplary diagram showing an example of an image drawn by the drawing section.

FIG. 23 is an exemplary diagram showing an example of an image drawn by the drawing section.

FIG. 24 is an exemplary diagram showing an example of an image drawn by the drawing section.

FIG. 25 is an exemplary diagram showing an example of an image drawn by the drawing section.

FIG. 26 is an exemplary flowchart showing a procedure for drawing images.

FIG. 27 is an exemplary diagram showing a desktop image perceived by a user.

### DETAILED DESCRIPTION

Various embodiments will be described hereinafter with reference to the accompanying drawings.

In general, according to one embodiment, an electronic apparatus is configured to draw, for generating a desktop image, a plurality of images comprising a first image comprising an image of a left eye perspective and an image of a right eye perspective based on drawing order information and drawing position information corresponding to the plurality of images, and to display an image based on the desktop image on a display screen of a display. The apparatus comprises a detection module, a processor, and a drawing module. The detection module is configured to detect an image from the plurality of images based on the drawing order information and a drawing size of each of the plurality of images, the detected image matching a predetermined condition. The processor is configured to process undetected images having failed to be detected by the detection module into processed images. Each of the processed images comprises an image of a left eye perspective and an image of a right eye perspective. The drawing module is configured to draw the detected image and the processed images based on the drawing order information and the drawing position information in order to generate the desktop image.

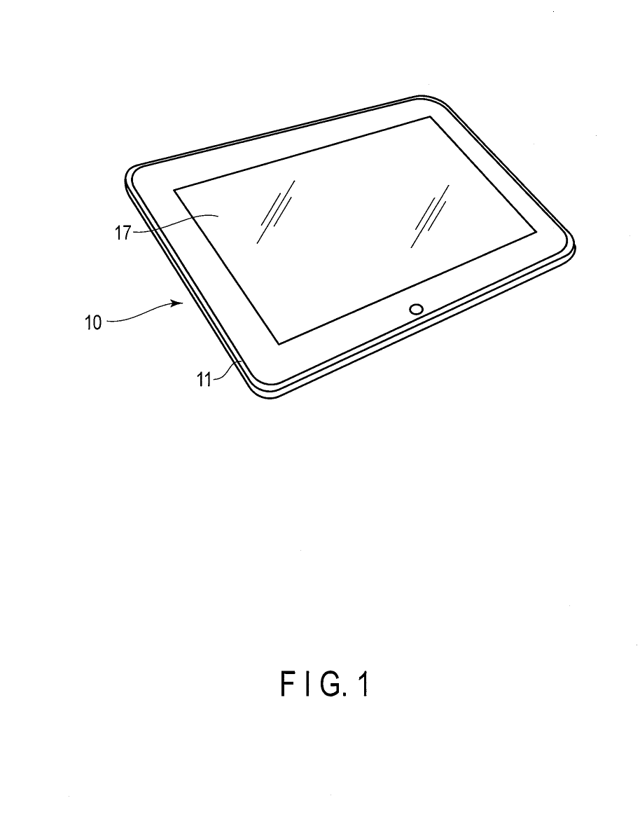

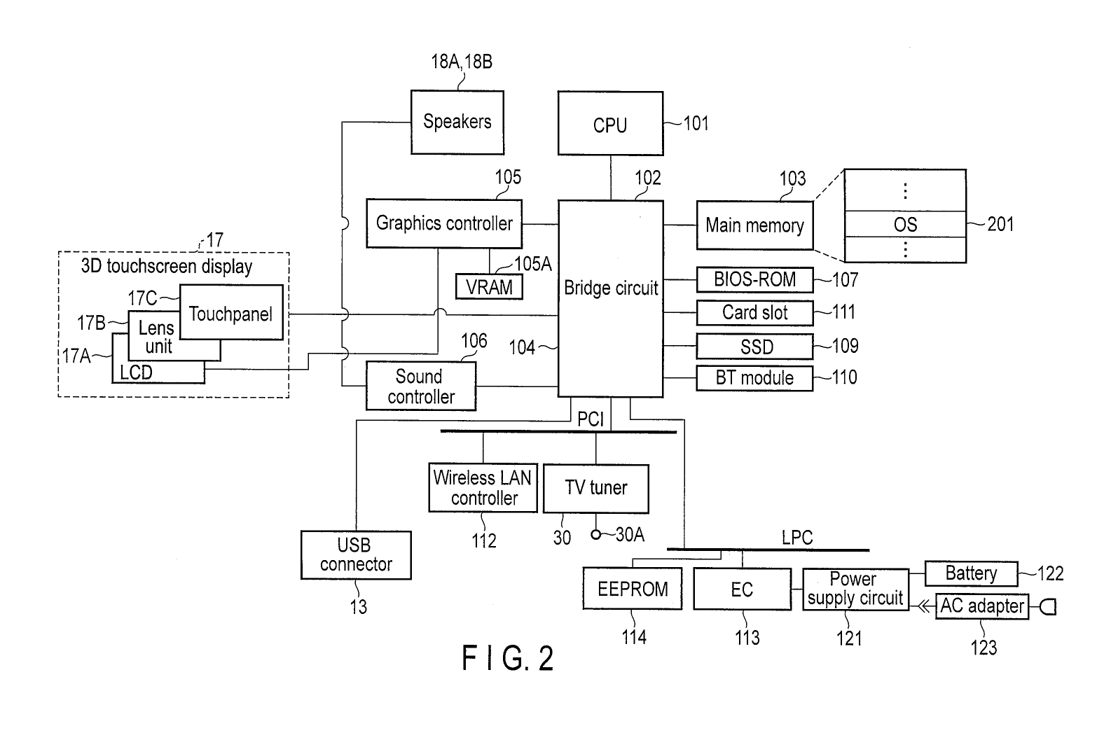

First, with reference to FIG. 1 and FIG. 2, a configuration of an electronic apparatus according to an embodiment will be described.

FIG. 1 is a perspective view showing the appearance of an electronic apparatus according to the embodiment. The electronic apparatus may be implemented as a tablet computer, a notebook computer, a smartphone, a PDA, or the like. It is hereinafter assumed that the electronic apparatus is implemented as a tablet computer 10. The tablet computer 10 is an electronic apparatus also referred to as a tablet or a slate computer, and comprises a main body 11 and a glasses-free three-dimensional touchscreen display (glasses-free 3D touchscreen display) 17. The glasses-free 3D touchscreen display 17 is mounted so as to overlap a top surface of the main body 11.

FIG. 2 is a block diagram showing an example of a system configuration of the computer system 10.

The computer 10 includes a central processing unit (CPU) 101, a bridge circuit 102, a main memory 103, a graphics controller (GPU) 105, a sound controller 106, a BIOS-ROM 107, a solid-state drive (SSD) 109, a Bluetooth (BT [registered trademark]) module 110, a card slot 111, a wireless LAN controller 112, a embedded controller (EC) 113, an EEPROM 114, a USB connector 13, a glasses-free 3D touchscreen display, and a video memory (VRAM) 105A.

The CPU 101 is a processor that controls operations of the sections in the computer 10. The CPU 101 executes an operating system (OS) 201 and various application programs loaded from the SSD 109 into the main memory 103.

The present embodiment assumes the OS 201 to be, for example, Android (registered trademark). That is, the present embodiment assumes a system that uses the Android OS and assumes the computer 10 to be a apparatus with the Android OS installed therein. According to the present embodiment, the OS 201 may be the computer 10 with an OS other than the Android OS installed therein. That is, such a system as described in the present embodiment can be applied to a system with another OS installed therein. Thus, such a system as described in the present embodiment can also be applied to the computer 10 with an OS other than the Android OS installed therein.

Furthermore, the CPU 101 executes a Basic Input/Output System (BIOS) stored in the BIOS-ROM 107. The BIOS is a program for hardware control.

The bridge circuit 102 is a bridge device that connects a local bus for the CPU 101 to devices on a Peripheral Component Interconnect (PCI) bus and devices on a Low Pin Count (LPC) bus. Furthermore, the bridge circuit 102 includes a built-in serial Advanced Technology Attachment (ATA) controller configured to control the SSD 109. Moreover, the bridge circuit 102 has a function to carry out communication with the sound controller 106. Alternatively, the bridge circuit 102 has a function to carry out communication with the GPU 105 via a serial bus conforming to the PCIEXPRESS standard.

The GPU 105 is a display controller that controls an LCD 17A that is used as a display monitor of the computer 10. Video signals (also referred to as display signals) generated by the GPU 105 are transmitted to the LCD 17A.

The sound controller 106 is a sound source device that outputs audio data to be reproduced to a speaker 18A and a speaker 18B. The wireless LAN controller 112 is a wireless communication device that carries out, for example, wireless communication conforming to the IEEE 802.11 standard.

The EC 113 is an embedded controller for power management. The EC 113 has a function to power on or off the computer 10 in accordance with a user's operation. A power supply circuit 121 generates operating power to components using power supplied by a battery 122 in the computer 10 or power supplied by an external power source such as an AC adapter 123. Furthermore, the power supply circuit 121 charges the battery 122 using power supplied by the external power source.

The glasses-free 3D touchscreen display 17 carries out stereoscopic display based on a glasses-free stereopsis scheme (for example, a lenticular scheme or a barrier scheme). The glasses-free touchscreen display 17 includes a liquid crystal display (LCD) 17A and a lens unit 17B disposed on the LCD 17A. The user can perceive a three-dimensional image with the naked eye by viewing an image displayed on the glasses-free 3D touchscreen display 17. The lens unit 17B includes a plurality of lens mechanisms configured to emit a plurality of light rays in the respective directions; the light rays correspond to a plurality of pixels contained in an image displayed on the LCD 17A. The lens unit 17B is, for example, a lenticular lens sheet that allows electric switching among functions required to display three-dimensional images. Turning the lens unit 17B on enables the user to perceive a stereoscopic image. Turning the lens unit 17B off allows the user to perceive normal two-dimensional image.

The glasses-free 3D touchscreen display 17 incorporates a touchpanel 17C in addition to the LCD 17A and the lens unit 17B. The touchpanel 17C, arranged so as to overlap the lens unit 17B, includes a sensor and a microcontroller unit (MCU). When a touch operation is performed on the touchpanel 17C, the touched position is detected by the sensor. Then, input information including the touched position on the touchpanel 17C is output by the MCU.

The computer 10 enables the user to perceive a wallpaper image on a desktop screen.

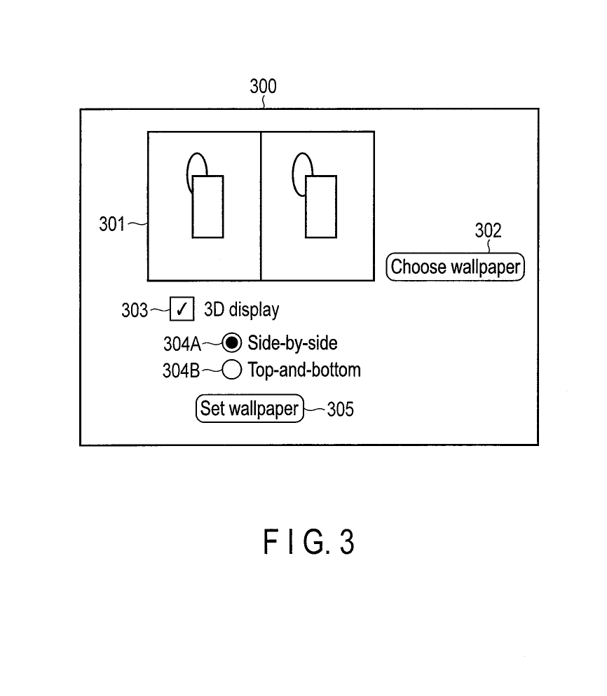

FIG. 3 is a diagram showing a setup screen for a wallpaper image. As shown in FIG. 3, a setup screen 300 contains a wallpaper display screen 301, a wallpaper selection button 302, a check button 303, option buttons 304A and 304B, and a setup button 305.

The wallpaper display area 301 displays a selected wallpaper image. When the wallpaper selection button 302 is operated, a screen that allows an image file for use as a wallpaper image to be selected from an image file stored in the SSD 109 is displayed. The check button 303 is operated to carry out a process of displaying an image that allows the user to perceive a stereoscopic image if a check mark is displayed. The option buttons 304A and 304B allow either a side-by-side format or a top-and-bottom format to be selected for the selected image. One of the option buttons 304A and 304B can be selected if the check mark is displayed. The setup button 305 allows setups to be completed.

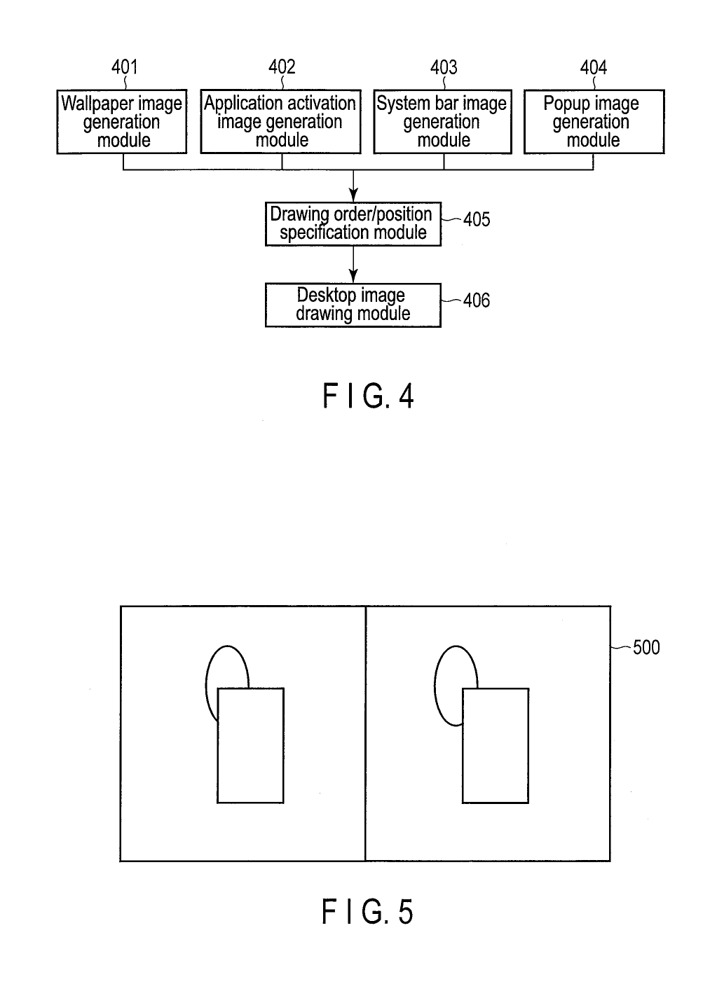

FIG. 4 is a block diagram showing a configuration for displaying the desktop screen on the LCD 17A.

As shown in FIG. 4, the configuration includes a wallpaper image generation module 401, an application activation image generation module 402, a system bar image generation module 403, a popup image generation module 404, a drawing image position specification module 405, and a desktop image drawing module 406.

The wallpaper image generation module 401 generates, in the main memory 103 or the VRAM 105A, a wallpaper image from an image file specified by the user using the setup screen. The wallpaper image generation module 401 generates a wallpaper image of a drawing size corresponding to the entire area of the display screen except for a system bar image area described below. FIG. 5 shows an example of a wallpaper image 500 generated by the wallpaper image generation module 401.

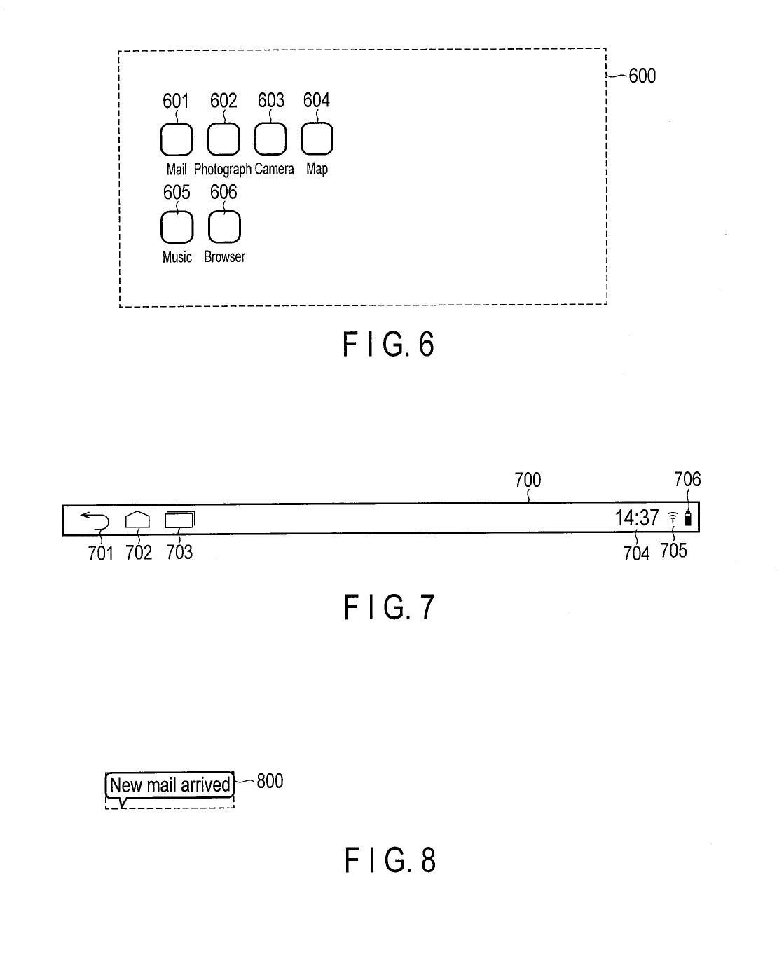

The application activation image generation module 402 generates an application activation image (second image) in the main memory 103 or the VRAM 105A; at least one icon for use in activating an application is arranged in the application activation image. The application activation image generated by the application activation image generation module 402 has the same drawing size as that of the wallpaper image 500 generated by the wallpaper image generation module 401. FIG. 6 shows an example of an application activation image 600 generated by the application activation image generation module 402.

As shown in FIG. 6, icons 601, 602, 603, 604, 605, and 606 are arranged in the application activation image 600; icon 601 is used to activate e-mail client software, icon 602 is used to activate a viewer that allows photographs to be browsed, icon 603 is used to activate an application that allows photographs to be taken using a camera, icon 604 is used to activate a map application, icon 605 is used to activate a music player, and icon 606 is used to activate a Web browser. The entire application activation image 600 except for the icons and relevant characters is transparent.

The system bar image generation module 403 generates a system bar image (third image) in the main memory 103 or the VRAM 105A; the system bar image displays buttons and system information that support the user's operation. FIG. 7 shows an example of a system bar image 700 generated by the system bar image generation module 403. As shown in FIG. 7, a return button 701, a home button 702, and a menu button are arranged in the system bar image 700; the return button 701, the home button 702, and the menu button support the user's operation. As shown in FIG. 7, the system bar image displays, as system information, time 704, an icon 705 indicative of an intensity at which a radio signal for use for a wireless LAN is received, and an icon 706 indicative of remaining battery charge.

The popup image generation module 404 generates a popup image (fourth image) in the main memory 103 or the VRAM 105A; the popup image presents a notification to the user. The popup image is displayed, for example, to notify the user of a newly arriving mail if a mailer has received the mail. FIG. 8 shows an example of a popup image 800 generated by the popup image generation module 404.

The application activation image 600, the system bar image 700, and the popup image 800 are not formed to allow the user to perceive stereoscopic images.

The drawing order/position specification module 405 determines the drawing order (z-order) of images generated by the wallpaper image generation module 401, the application activation image generation module 402, the system bar image generation module 403, and the popup image generation module 404, and the drawing positions of these images in the display screen of the LCD. The drawing order/position specification module 405 generates drawing information indicative of the determined drawing order and positions.

The drawing information includes a first piece of storage position information indicative of the storage position of a wallpaper image in the memory (main memory 103 or VRAM 105A), a first piece of drawing order information indicative of the drawing order of the wallpaper image, and a first piece of drawing position information indicative of the drawing position of the wallpaper image in the screen. The first piece of drawing order information and the first piece of drawing position information are associated with the first piece of storage position information.

The drawing information includes a second piece of storage position information indicative of the storage position of an application activation image in the memory (main memory 103 or VRAM 105A), a second piece of drawing order information indicative of the drawing order of the application activation image, and a second piece of drawing position information associated with the second piece of storage position information and which is indicative of the drawing position of the application activation image in the screen. The second piece of drawing order information and the second piece of drawing position information are associated with the second piece of storage position information.

The drawing information includes a third piece of storage position information indicative of the storage position of a system bar image in the memory (main memory 103 or VRAM 105A), a third piece of drawing order information indicative of the drawing order of the system bar image, and a third piece of drawing position information indicative of the drawing position of the system bar image in the screen. The third piece of drawing order information and the third piece of drawing position information are associated with the third piece of storage position information.

The drawing information includes a fourth piece of storage position information indicative of the storage position of a popup image in the memory (main memory 103 or VRAM 105A), a fourth piece of drawing order information indicative of the drawing order of the popup image, and a fourth piece of drawing position information indicative of the drawing position of the popup image in the screen. The fourth piece of drawing order information and the fourth piece of drawing position information are associated with the fourth piece of storage position information.

The first piece of storage position information to the fourth piece of storage position information are information indicative of the leading address and size of each of the images in memory (main memory 103 or VRAM 105A) or information such as pointers which is indicative of areas in the memory.

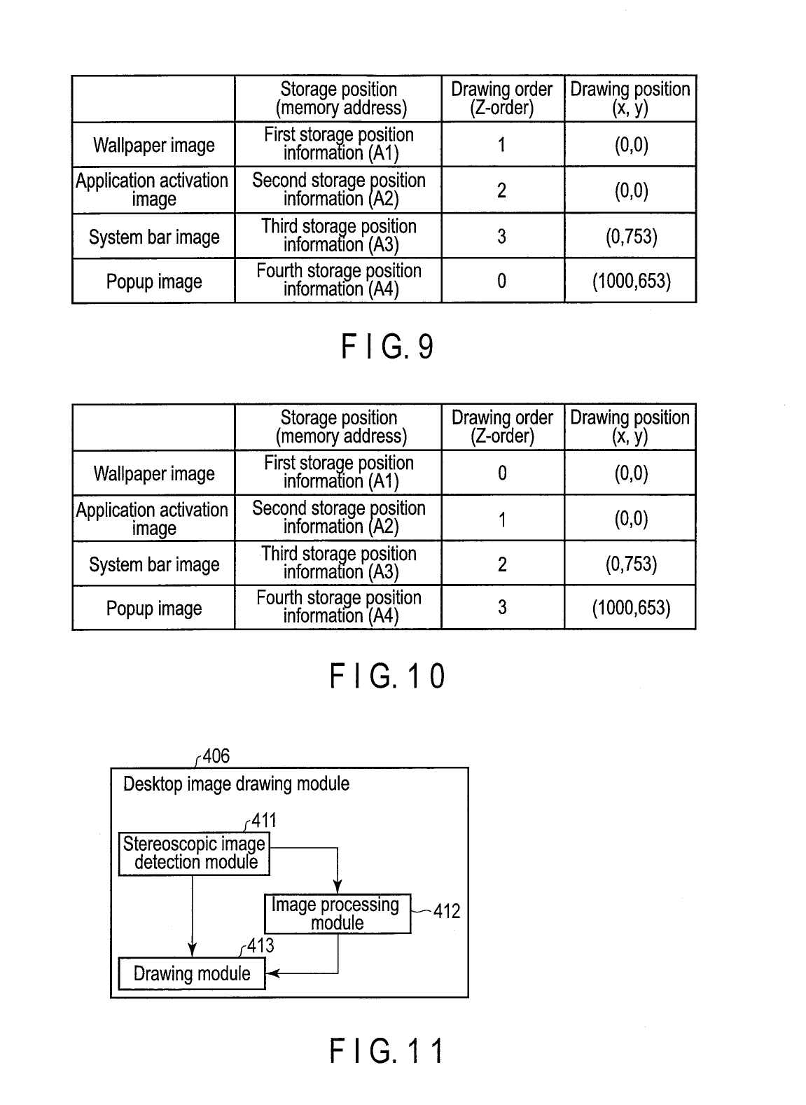

For example, if e-mail client software has not received any new mail and there is no notification to the user, the drawing order/position specification module 405 specifies the drawing order such that the popup image, the wallpaper image, the application activation image, and the system bar image are drawn in this order from the bottom of the screen. FIG. 9 shows drawing information created by the drawing order/position specification module 405 in this case.

Furthermore, for example, if the e-mail client software has received a new mail and there is a notification to the user, the drawing order/position specification module 405 specifies the drawing order such that the wallpaper image, the application activation image, the system bar image, and the popup image are drawn in this order from the bottom of the screen. FIG. 10 shows drawing information created by the drawing order/position specification module 405 in this case. The drawing position of the popup image does not vary regardless of whether or not there is a notification to the user.

Values in FIG. 9 and FIG. 10 which are indicative of the drawing order indicate the order in which the images are drawn. Furthermore, the drawing positions are expressed in an xy coordinate system with an origin located in the upper left corner of the LCD. An x-axis corresponds to the horizontal direction. A y-axis corresponds to the vertical direction.

Based on the drawing formation, the desktop image drawing module 406 displays the images in a predetermined area in the main memory 103 or the VRAM 105A in order of increasing drawing order value. Each of the wallpaper image, the application activation image, the system bar image, and the popup image includes a mixture of a normal image (hereinafter referred to as a plane image) and an image created to allow the user to perceive a stereoscopic image (hereinafter referred to as a stereopsis image). When the image is drawn without any change, the user views an abnormal image. Thus, the plane image is processed into an image including a video for the left eye and a video for the right eye. The processed image may be stored in the main memory 103 or the VRAM 105A at the same position as that where the unprocessed image is stored. The same storage position eliminates the need to change the storage position information in the drawing information.

FIG. 11 is a block diagram showing a configuration of the desktop image drawing module 406. The desktop image drawing module 406 includes a stereopsis image detection module 411, an image processing module 412, and a drawing module 413.

The stereopsis image detection module 411 determines a stereopsis image included in the plurality of images (for example, the wallpaper image 500, the application activation image 600, the system bar image 700, and the popup image 800) prepared to draw the desktop image based on each piece of drawing image information and each piece of drawing position information to match a predetermined condition. The wallpaper image is drawn under the application activation image and has the same drawing size as that of the application activation image. Utilizing this, the stereopsis image detection module 411 detects a stereopsis image. The predetermined condition is that over an image, another image of the same drawing size is drawn.

The image processing module 412 processes an image having failed to be determined by the stereopsis image detection module 411 to be a stereopsis image, into an image with a video for the left eye and a video for the right eye. If the wallpaper image is in a side-by-side format and the image having failed to be determined by the stereopsis image detection module 411 to be a stereopsis image is equal to the LCD 17A in the number of pixels arranged in the horizontal direction, the image processing module 412 reduces the pixels arranged in the image in the horizontal direction to half to generate a new image. The image processing module 412 arranges the halved image and a subsequently generated image in the horizontal direction to generate a new image.

If the wallpaper image is in the side-by-side format and the image having failed to be determined by the stereopsis image detection module 411 to be a stereopsis image is not equal to the LCD 17A in the number of pixels arranged in the horizontal direction, the image processing module 412 generates an image which is equal to the LCD 17A in the number of pixels arranged in the horizontal direction and which is located at a position based on the drawing position of the image. The image processing module 412 then reduces the pixels of the image in the horizontal direction to half to generate a new image. The image processing module 412 arranges the halved image and a subsequently generated image in the horizontal direction to generate a new image.

If the wallpaper image is in a top-and-bottom format, and the image is equal to the LCD 17A in the number of pixels arranged in the vertical direction, the image processing module 412 reduces the pixels arranged in the image in the vertical direction to half to generate a new image. The image processing module 412 then arranges the halved image and a subsequently generated image in the vertical direction to generate a new image.

If the wallpaper image is in the top-and-bottom format, and the image is not equal to the LCD 17A in the number of pixels arranged in the vertical direction, the image processing module 412 generates an image which is equal to the LCD 17A in the number of pixels arranged in the vertical direction and which is located at a position based on the drawing position of the image. The image processing module 412 then reduces the pixels of the image in the vertical direction to half to generate a new image. The image processing module 412 arranges the halved image and a subsequently generated image in the vertical direction to generate a new image.

An example of processing of the application activation image 600, the system bar image 700, and the popup image 800 will be discussed below.

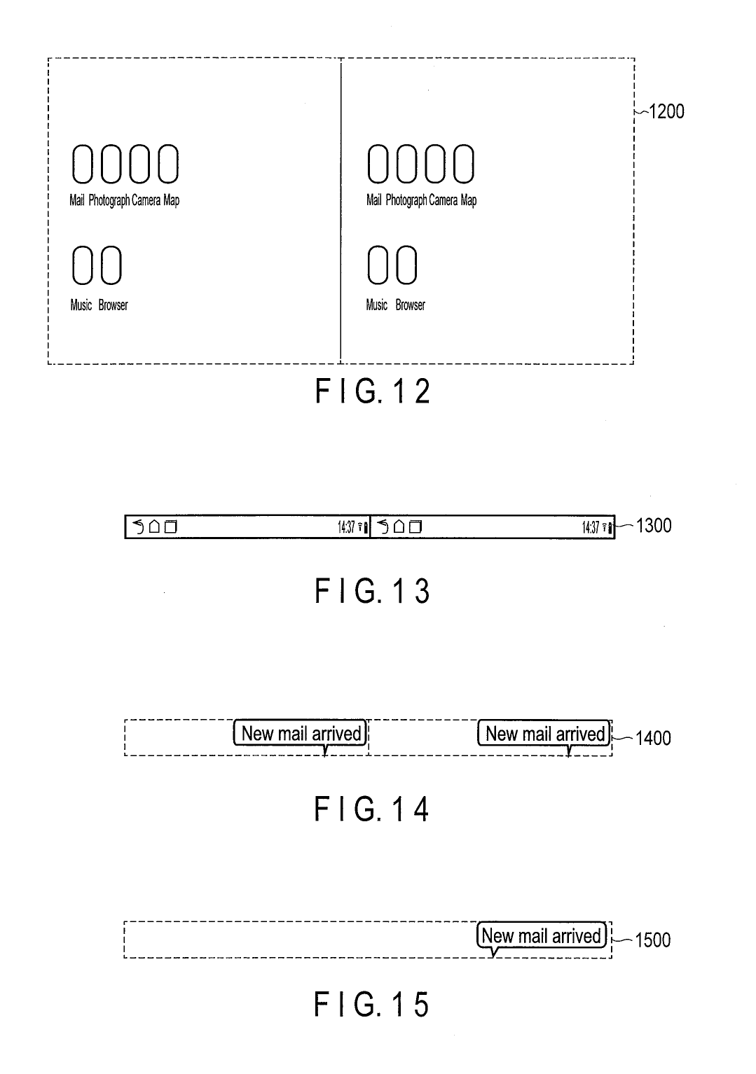

For example, the image processing module 412 processes the application activation image 600 shown in FIG. 6 into an application activation image 1200 shown in FIG. 12. For example, the image processing module 412 processes the system bar image 700 shown in FIG. 7 into a system bar image 1300 shown in FIG. 13. For example, the image processing module 412 processes the popup image 800 shown in FIG. 8 into a popup image 1400 shown in FIG. 14.

The number of pixels of the popup image 800 in the horizontal direction is smaller than the number of pixels arranged in the LCD 17 in the horizontal direction. Thus, the image processing module 412 generates a popup image 1500 equal to the LCD 17A in the number of pixels arranged in the horizontal direction (FIG. 15). Then, the image processing module 412 reduces the pixels arranged in the generated popup image 1500 in the vertical direction to half and arranges the halved image and a subsequently generated image in the vertical direction. Thus, the popup image 800 is processed into the popup image 1400.

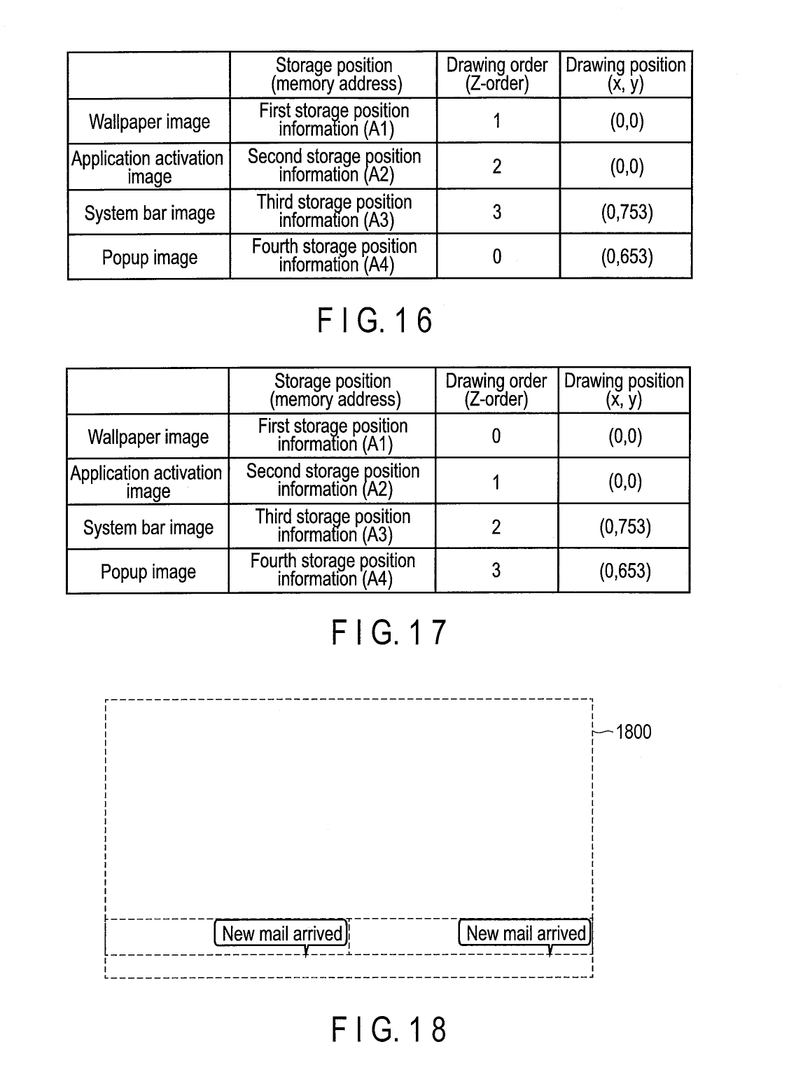

Furthermore, the image processing module 412 changes drawing position information (1000, 653) in drawing information on the popup image in FIG. 9 and FIG. 10 to drawing position information (0, 653) as shown in FIG. 16 and FIG. 17, based on the drawing position of the popup image 1400.

The drawing module 413 draws the image detected by the stereopsis image detection module 411 and image processed by the image processing module 412, in a predetermined area in the main memory 103 or the VRAM 105A.

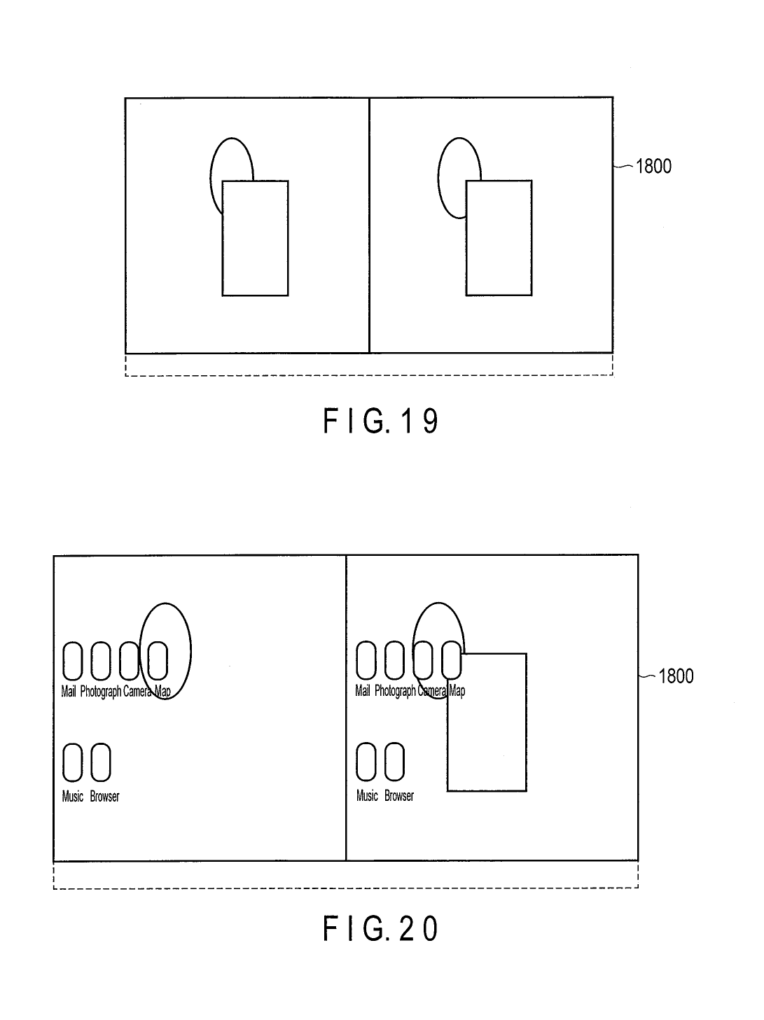

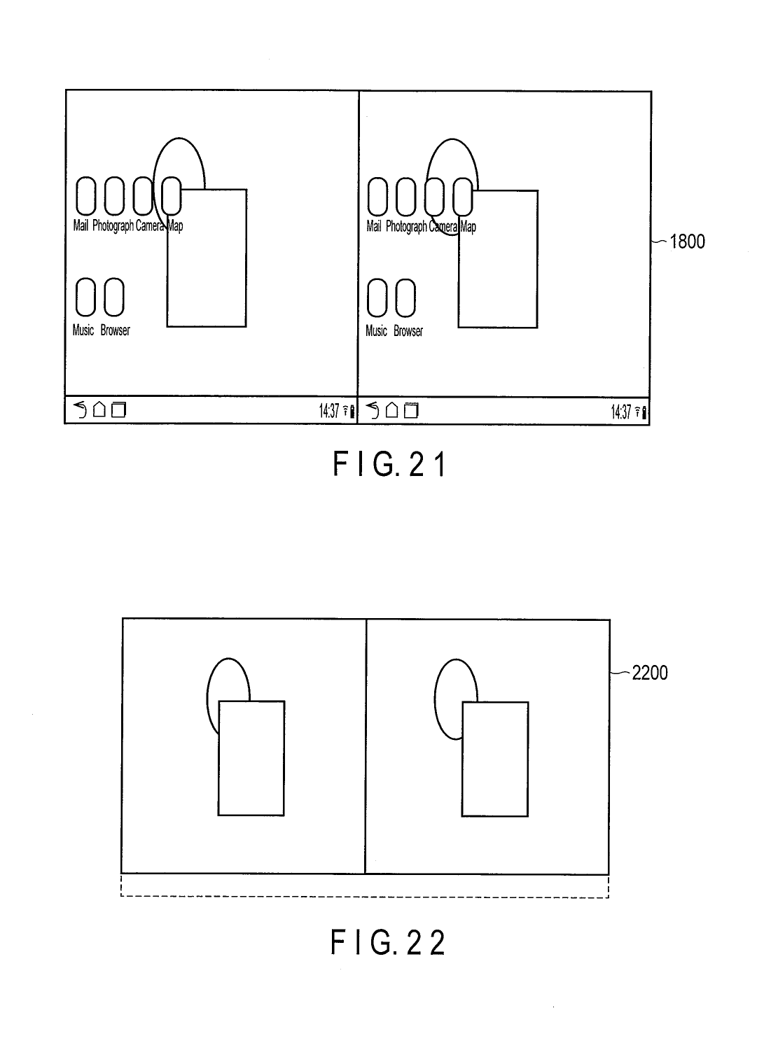

A case where the drawing module 413 carries out drawing based on the drawing information shown in FIG. 16 will be described. First, as shown in FIG. 18, the drawing module 413 draws the popup image 1400 in a drawing area 1800 based on the drawing position information in the drawing information. Then, as shown in FIG. 19, the drawing module 413 draws the wallpaper image 500 in the drawing area 1800 based on the drawing position information in the drawing information. Then, as shown in FIG. 20, the drawing module 413 draws the application activation image 1200 in the drawing area 1800 based on the drawing position information in the drawing information. Finally, as shown in FIG. 21, the drawing module 413 draws the system bar image 1300 in the drawing area 1800 based on the drawing position information in the drawing information to draw a desktop image.

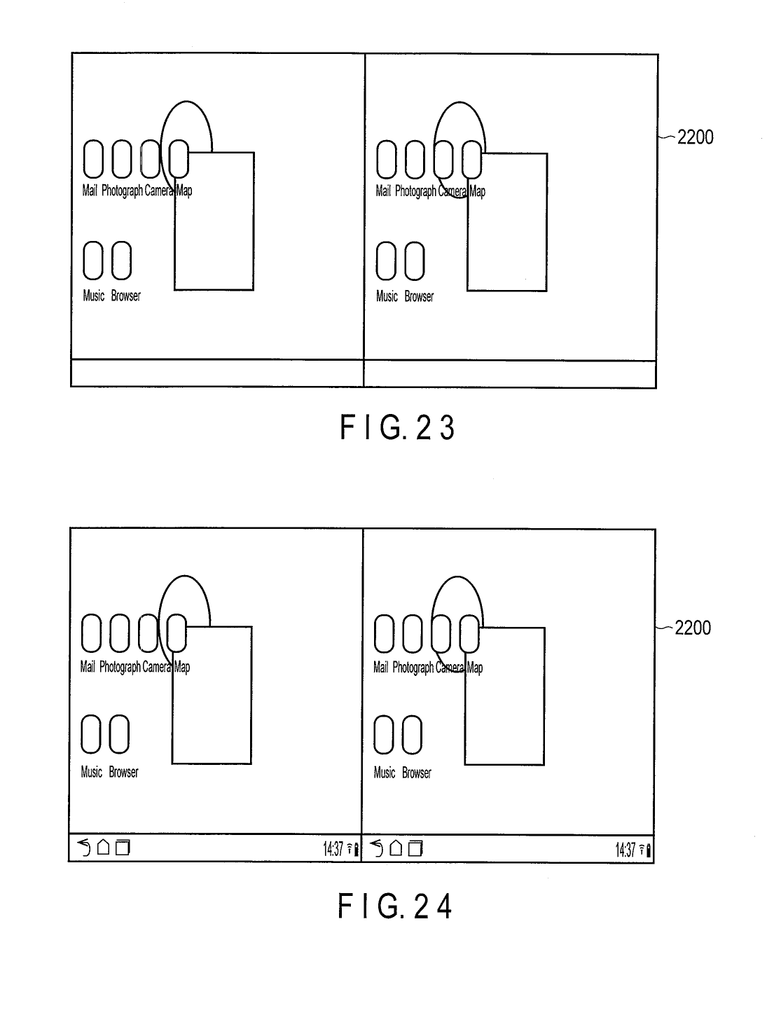

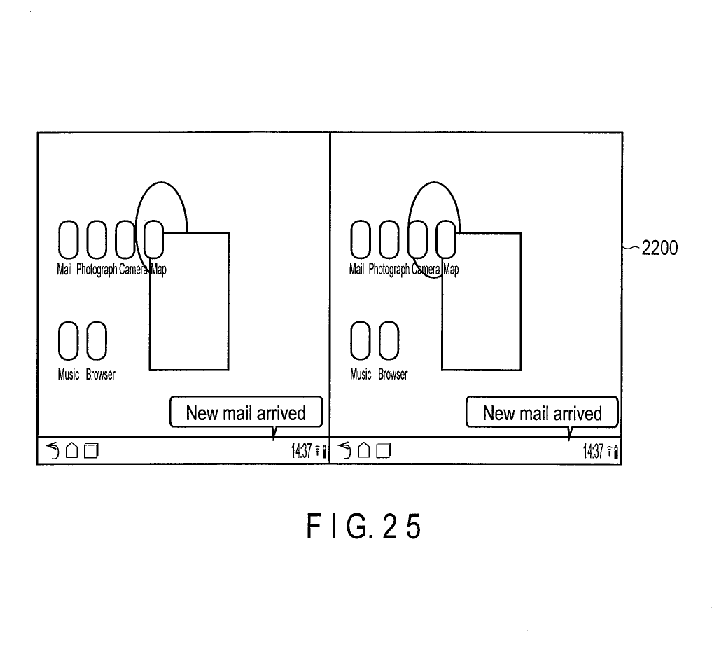

A case where the drawing module 413 carries out drawing based on the drawing information shown in FIG. 17 will be described. First, as shown in FIG. 22, the drawing module 413 draws the wallpaper 500 in a drawing area 2200 based on the drawing position information in the drawing information. Then, as shown in FIG. 23, the drawing module 413 draws the application activation image 1200 in the drawing area 2200 based on the drawing position information in the drawing information. Then, as shown in FIG. 24, the drawing module 413 draws the system bar image 1300 in the drawing area 2200 based on the drawing position information in the drawing information. Finally, as shown in FIG. 25, the drawing module 413 draws the popup image 1400 in the drawing area 2200 based on the drawing position information in the drawing information to draw a desktop image.

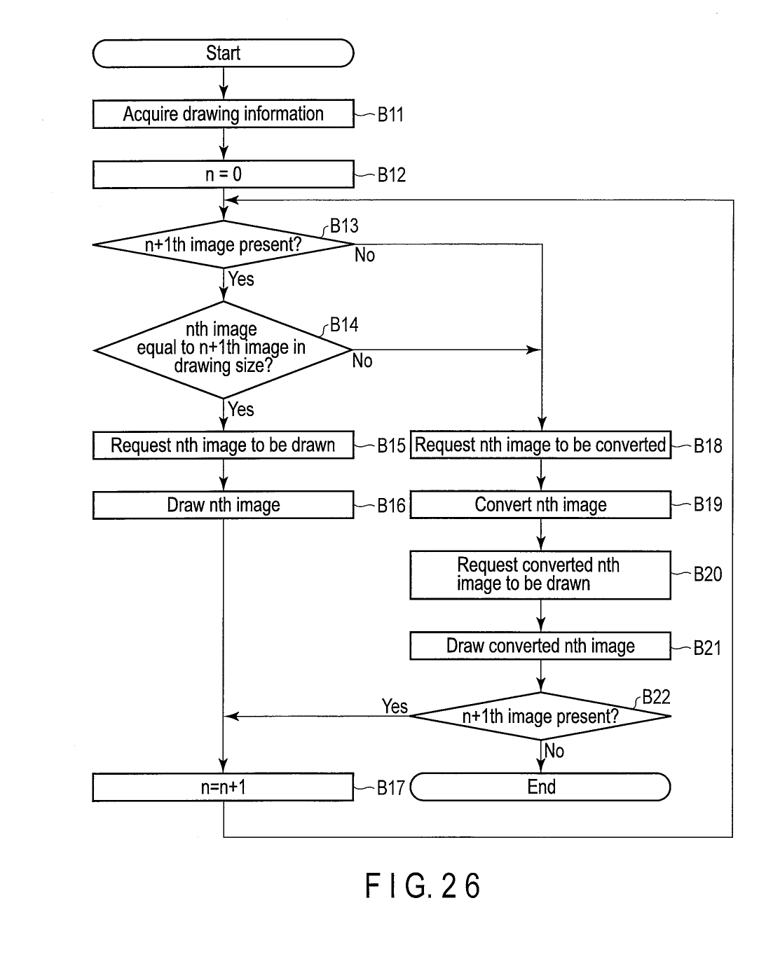

FIG. 26 is a flowchart showing a procedure for drawing the images.

First, the stereopsis image detection module 411 acquires drawing information (block B11). The stereopsis image detection module 411 sets n=0 (block B12). Based on the drawing information, the stereopsis image detection module 411 determines whether the n+1^{th} image to be drawn is present (block B13). If the stereopsis image detection module 411 determines that the n+1^{th} image to be drawn is present (Yes in block B13), the stereopsis image detection module 411 determines whether the n^{th} image has the same size as that of the n+1^{th} image (block B14). If the stereopsis image detection module 411 determines that the n^{th} image has the same size as that of the n+1^{th} image (Yes in block B14), the stereopsis image detection module 411 requests the drawing module 413 to draw the n^{th} image (block B15). The drawing module 413 draws the image in the n^{th} layer (block B16). When the drawing is finished, the drawing module 413 notifies the stereopsis image detection module 411 that the drawing of the n^{th} image is finished. The stereopsis image detection module 411 sets n=n+1 (block B17). After block B17, the processing starting from block B13 is sequentially carried out.

Upon determining that the n+1^{th} image to be drawn is not present (No in block B13) or that the n^{th} image does not have the same drawing size as that of the n+1^{th} image (No in block B14), the stereopsis image detection module 411 requests the image processing module 412 to process the n^{th} image (block B18). In response to the request, the image processing module 412 processes the n^{th} image (block B19). The image processing module 412 requests the drawing module 413 to draw the n^{th} image (block B20). The drawing module 413 draws the image in the n^{th} layer (block B21). The drawing module 413 notifies the stereopsis image detection module 411 that the drawing of the n^{th} image is finished. The stereopsis image detection module 411 determines whether the n+1^{th} image is present (block B22). Upon determining that the n+1^{th} image is present (Yes in block B22), the stereopsis image detection module 411 sets n=n+1 (block B17). After block B17, the processing starting from block B13 is sequentially carried out. If the stereopsis image detection module 411 determines that the n+1^{th} image is not present (No in block B22), the drawing process ends.

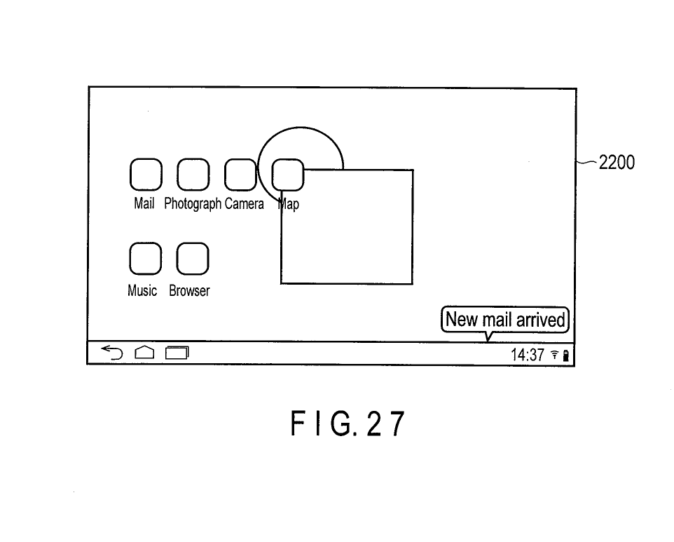

After the drawing process ends, the image is transmitted to the GPU 105. The GPU 105 generates a video signal as allows the user to perceive a video image based on the drawn image. The GPU 105 transmits the generated video signal to the LCD 17A. As shown in FIG. 27, the user perceives a normal desktop image 2600.

In the above-described example, stereoscopic display is provided based on the glasses-free stereopsis scheme. However, stereoscopic display may be provided using a liquid crystal shutter or a polarizing lens.

As described above, if two of a plurality of images which are the same in size are contiguous with each other, the first drawn image is processed into an image for stereoscopic display, whereas the second drawn image is processed into an image for normal display. Then, the image for normal display and the image for stereoscopic display can be easily distinguished from each other without the need to add data such as a special flag.

The various processes for stereoscopic display according to the present embodiment can be carried out by a computer program. Thus, effects similar to those of the present embodiment can be easily exerted simply by installing this compute program in a normal computer through a computer readable storage medium and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus configured to draw, for generating a desktop image, a plurality of images comprising a first image comprising an image of a left eye perspective and an image of a right eye perspective based on drawing order information and drawing position information corresponding to the plurality of images, and to display an image based on the desktop image on a display screen of a display, the apparatus comprising:
a detection module configured to detect an image from the plurality of images based on the drawing order information and a drawing size of each of the plurality of images, the detected image matching a predetermined condition;
a processor configured to process undetected images having failed to be detected by the detection module into processed images, each of the processed images comprising an image of a left eye perspective and an image of a right eye perspective; and
a drawing module configured to draw the detected image and the processed images based on the drawing order information and the drawing position information in order to generate the desktop image.

2. The apparatus of claim 1, wherein the predetermined condition comprises a condition that the detected image and an image drawn over the detected image are equal in size.

3. The apparatus of claim 1, further comprising:
a first image generator configured to generate the first image, wherein the first image is indicated by a first drawing order information in the drawing order information, the first image is drawn under a second image, and a drawing position of the first image in the display screen is indicated by a first drawing position information in the drawing position information;
a second image generator configured to generate the second image, wherein the second image is indicated by a second drawing order information in the drawing order information, the second image is drawn over the first image, a drawing position of the second image in the display screen is indicated by a second drawing position information in the drawing position information, the second image is identical to the first image in drawing size, and the second image comprises an icon for activating an application program;
a third image generator configured to generate a third image, wherein the third image is indicated by a third drawing order information in the drawing order information, the third image is drawn over the second image, a drawing position of the third image in the display screen is indicated by a third drawing position information in the drawing position information, the third image is different from the first image in drawing size, and the third image presents system information to be viewed; and
a fourth image generator configured to generate a fourth image, wherein the fourth image is indicated by a fourth drawing order information in the drawing order information, the fourth image is drawn under the first image or over the third image, a drawing position of the fourth image in the display screen is indicated by a fourth drawing position information in the drawing position information, the fourth image is different from the first image in drawing size, and the fourth image presents a notification.

4. The apparatus of claim 1, wherein the first image comprises a side-by-side format,
when a second image in the undetected images is equal to the display screen in the number of pixels in a horizontal direction, the processor is configured to reduce the number of pixels of the second image in the horizontal direction to half for generating a third image and to arrange the third image and a subsequently generated image in the horizontal direction in order to generate a fourth image, and
when a fifth image in the undetected images is not equal to the display screen in the number of pixels in the horizontal direction, the processor is configured to generate a sixth image comprising the fifth image, to reduce the number of pixels of the sixth image in the horizontal direction to half for generating a seventh image, and to arrange the seventh image and a subsequently generated image in the horizontal direction in order to generate an eighth image, wherein the sixth image is equal to the display screen in the number of pixels in the horizontal direction, the fifth image included in the sixth image is arranged at a position based on a first drawing position information in the drawing position information, and the first drawing position information corresponds to the fifth image.

5. The apparatus of claim 4, wherein the processor is configured to change one item of the drawing position information depending on a drawing position of the eighth image.

6. The apparatus of claim 1, wherein the first image is in a top-and-bottom format,
when a second image in the undetected images is equal to the display screen in the number of pixels arranged in a vertical direction, the processor is configured to reduce the number of pixels of the second image arranged in the vertical direction to half for generating a third image, and to arrange the third image and a subsequently generated image in the vertical direction for generating a fourth image, and
when a fifth image in the undetected images is not equal to the display screen in number of pixels arranged in the vertical direction, the processor is configured to generate a sixth image comprising the fifth image, to reduce the number of pixels of the sixth image arranged in the vertical direction to half for generating a seventh image, and to arrange the seventh image and subsequently generated image in the vertical direction in order to generate an eighth image, wherein the sixth image is equal to the display screen in number of pixels arranged in the vertical direction, and the sixth image is arranged at a position in the fifth image included in the sixth image being arranged at a position based on a first drawing position information in the drawing position information, the first drawing position information corresponds to the fifth image.

7. The apparatus of claim 6, wherein the processor is configured to change one item of the drawing position information depending on a drawing position of the eighth image.

8. A desktop image display method of drawing a plurality of images comprising a first image comprising an image of a left eye perspective and an image of a right eye perspective based on drawing order information and drawing position information corresponding to the plurality of images, thereby generating a desktop image, and displaying an image based on the desktop image on a display screen of a display, the method comprising:
detecting an image from the plurality of images based on the drawing order information and a drawing size of each of the plurality of images, the detected image matching a predetermined condition;
processing undetected images having failed to be detected by the detecting into processed images, each of the processed images comprising an image of a left eye perspective and an image of a right eye perspective; and
drawing the detected image and the processed images based on the drawing order information and the drawing position information in order to generate the desktop image.

9. The method of claim 8, wherein the predetermined condition comprises a condition that the detected image and an image drawn over the detected image are equal in size.

10. The method of claim 8, further comprising:
generating the first image, wherein the first image is indicated by a first drawing order information in the drawing order information, the first image is drawn under a second image, and a drawing position of the first image in the display screen is indicated by a first drawing position information in the drawing position information;
generating the second image, wherein the second image is indicated by a second drawing order information in the drawing order information, the second image is drawn over the first image, and a drawing position of the second image in the display screen is indicated by a second drawing position information in the drawing position information, the second image is identical to the first image in drawing size, and the second image includes an icon for activating an application program;
generating a third image, wherein the third image is indicated by a third drawing order information in the drawing order information, the third image is drawn over the second image, a drawing position of the third image in the display screen is indicated by a third drawing position information in the drawing position information, the third image is different from the first image in drawing size, and the third image presents system information to be viewed; and
generating a fourth image, wherein the fourth image is indicated by a fourth drawing order information in the drawing order information, the fourth image is drawn under the first image or over the third image, a drawing position of the fourth image in the display screen is indicated by a fourth drawing position information in the drawing position information, the fourth image is different from the first image in drawing size, and the fourth image presents a notification.

11. The method of claim 8, wherein the first image comprises a side-by-side format,
when a second image in the undetected images is equal to the display screen in the number of pixels in a horizontal direction, the processing comprises:
reducing the number of pixels of the second image in the horizontal direction to half for generating a third image; and
arranging the third image and a subsequently generated image in the horizontal direction in order to generate a fourth image,
when a fifth image in the undetected images is not equal to the display screen in the number of pixels in the horizontal direction, the processing comprises:
generating a sixth image comprising the fifth image, wherein the sixth image is equal to the display screen in number of pixels in the horizontal direction, the fifth image is included in the sixth image is arranged at a position based on a first drawing position in the drawing position information, and the first drawing position corresponds to the fifth image;
reducing the number of pixels of the sixth image in the horizontal direction to half for generating a seventh image; and
arranging the seventh image and a subsequently generated image in the horizontal direction in order to generate a an eighth image.

12. The method of claim 11, wherein drawing position information corresponding to the fifth image is changed depending on a drawing position of the eighth image.

13. The method of claim 7, wherein the first image comprises a top-and-bottom format,
when a second image in the undetected images is equal to the display screen in the number of pixels arranged in a vertical direction, the processing comprises:
reducing the number of pixels of the second image arranged in the vertical direction to half for generating a third image; and
arranging the third image and a subsequently generated image in the vertical direction in order to generate a fourth image, and
when a fifth image in the undetected images is not equal to the display screen in number of pixels arranged in the vertical direction, the processing comprises:
generating a sixth image comprising the fifth image, wherein the sixth image is equal to the display screen in the number of pixels arranged in the vertical direction, the sixth image is arranged at a position in the fifth image included in the sixth image, the sixth image is arranged at a position based on a first drawing position information in the drawing position information, the first drawing position information corresponds to the fifth image;
reducing the number of pixels arranged in the sixth image in the vertical direction to half for generating a seventh image; and
arranging the seventh image and a subsequently generated image in the vertical direction in order to generate an eighth image.

14. The desktop image display method of claim 13, wherein drawing position information corresponding to the fifth image is changed depending on a drawing position of the eighth image.
